(19) United States
(12) Patent Application Publication
(10) Pub. No.: US 2018/0174197 A1
(43) Pub. Date: Jun. 21, 2018

(54) GENERATING A CONTENT ITEM FOR PRESENTATION TO AN ONLINE SYSTEM INCLUDING CONTENT FROM AN APPLICATION DESCRIBING A PRODUCT SELECTED BY THE ONLINE SYSTEM

(71) Applicant: Facebook, Inc., Menlo Park, CA (US)

(72) Inventors: Tao Cui Baecklund, San Jose, CA (US); Mina Maher Shawky Abouseif, Sammamish, WA (US); Robert Morgan Banks, Palo Alto, CA (US); Jinghao Yan, Cupertino, CA (US); Owen H. Coutts, Seattle, WA (US); Jehan Damji, San Francisco, CA (US)

(21) Appl. No.: 15/387,494

(22) Filed: Dec. 21, 2016

(51) Int. Cl. G06Q 30/02; G06Q 50/00

(52) U.S. Cl. CPC G06Q 30/0269; G06Q 50/01; G06Q 30/0254

(57) ABSTRACT

A content item maintained by an online system has a creative presenting content including a product from an application associated with a third party system. When the online system identifies an opportunity to present the content item to the user, the online system selects a product associated with the third party system based on content from one or more third party systems accessed by the user. The online system includes the content item with the creative including content from the application including the selected product in one or more selection processes. If the content item with the creative including content from the application including the selected product is presented to the user and the online system receives an indication the application was installed on a client device, the online system provides instructions to the client device to present content associated with the selected product.

### BACKGROUND

This disclosure relates generally to presenting content to users of an online system, and more specifically to generating a content item including content from an application describing a product selected by the online system.

Online systems, such as social networking systems, allow users to connect to and to communicate with other users of the online system. Users may create profiles on an online system that are tied to their identities and include information about the users, such as interests and demographic information. The users may be individuals or entities such as corporations or charities. Online systems allow users to easily communicate and to share content with other online system users by providing content to an online system for presentation to other users. Content provided to an online system by a user may be declarative information provided by a user, status updates, check-ins to locations, images, photographs, videos, text data, or any other information a user wishes to share with additional users of the online system. An online system may also generate content for presentation to a user, such as content describing actions taken by other users on the online system.

Additionally, many online systems commonly allow publishing users (e.g., businesses) to sponsor presentation of content on an online system to gain public attention for a user's products or services or to persuade other users to take an action regarding the publishing user's products or services. Content for which the online system receives compensation in exchange for presenting to users is referred to as “sponsored content.” Many online systems receive compensation from a publishing user for presenting online system users with certain types of sponsored content provided by the publishing user. Frequently, online systems charge a publishing user for each presentation of sponsored content to an online system user or for each interaction with sponsored content by an online system user. For example, an online system receives compensation from a publishing user each time a content item provided by the publishing user is displayed to another user on the online system or each time another user is presented with a content item on the online system and interacts with the content item (e.g., selects a link included in the content item), or each time another user performs another action after being presented with the content item.

Various publishing users or third party systems may provide the online system with content items identifying applications for online system users to install on client device. For example, a third party system provides the online system with a content item including content from an application associated with the third party system and information about the application to entice online system users to whom the content item is presented to install the application. However, different users may have varying levels of interest in the content from the application included in the presented content item. For example, if various products are offered for sale or review by the application, if a publishing user selects content from the application about a particular product for inclusion in the content item, users who are uninterested in the particular product may be less inclined to subsequently install the application. If content from the application about an alternative product were included in the content item, different users may be more inclined to subsequently install the application. While generating multiple content items including content describing content form the application about multiple products and providing the multiple content items to the online system for presentation may increase a number of online system users who install the application, generating and maintaining a large number of content items consumes significant resources of and time of the third party system or publishing user.

### SUMMARY

An online system receives a content item for presentation to one or more users of the online system that includes a creative presenting content from an application that includes a product. For example, the creative includes content from the application describing the product or information from the application for purchasing the product. To increase a likelihood of users interacting with the content item when it is presented, the content item includes instructions that cause the online system to select the product included in the creative and to generate the creative for the content item including the selected product. Hence, rather than identify specific content that is presented to each user to whom the content item is presented, the instructions included in the content item allow the online system to dynamically identify the product presented by the creative for different users. The application from which content including the product is included in the creative may be associated with a third party system or may be associated with the online system.

Additionally, the online system receives information identifying content provided by various third party systems accessed by a user. In various embodiments, content provided by different third party systems includes information describing products associated with or provided by a third party system, and the online system receives information identifying products described by content from the third party system accessed by the user. For example, a third party system includes a tracking mechanism in content presented to users. The tracking mechanism comprises instructions that, when executed by a client device presenting the content, obtain information identifying one or more products included in the content and information identifying the user to the online system and communicate the information identifying the one or more products and identifying the user to the online system. In various embodiments, the tracking mechanism may communicate additional information to the online system describing interaction with the content by the user of the online system. For example, the tracking mechanism communicates information describing one or more interactions by the user with various portions of the presented content corresponding to an identified product to the online system.

Third party systems provide the online system with information describing products associated with or provided by the third party systems. For example, a third party system provides the online system with a catalog including product identifiers used by the third party system for various products. The catalog also includes characteristics associated with different products by the third party system. For example, the catalog includes a product identifier associated with a product by the third party system as well as a title, a description, one or more keywords, and any other suitable information associated with the product identifier. Different third party systems may provide the online system with different characteristics associated with products.

Based on the received information identifying content provided by one or more third party systems accessed by the user and the provided information describing products associated with or provided by one or more third party systems, the online system identifies one or more products for presentation to the user. In various embodiments, the online system compares characteristics of content accessed by the user to characteristics of products associated with or provided by various third party systems and identifies one or more products having at least a threshold amount (e.g., at least a threshold number or at least a threshold percentage) of characteristics matching characteristics of content accessed by the user. For example, the online system determines products included in content accessed by the user, obtains characteristics of the determined products, and identifies additional products having at least a threshold amount of characteristics matching characteristics of the determined products. As another example, the online system extracts keywords, topics, or other information from the content accessed by the user and identifies products described by the provided information having at least the threshold amount of characteristics matching the extracted keywords, topics, or other information.

When the online system identifies an opportunity to present one or more content items to the user, the online system selects a product of the identified products. To select the product, the online system may determine products associated with a third party system associated with the application and determines likelihoods of the user interacting with content including each of at least a set of the determined products. For example, the online system generates different content items that each include an identified product associated with the third party system associated with the application and determines likelihoods of the user interacting with each of the generated content items. To determine a likelihood of the user interacting with a generated content item, the online system applies one or more models to characteristics of the user and characteristics of the generated content item. The one or more models may be based on prior interactions by the user with previously presented content items. Based on the determined likelihoods, the online system selects a product. For example, the online system selects an identified product included in a generated content item with which the user had a maximum likelihood of interacting. In other embodiments, the online system selects an identified product matching a product included in content accessed by the user. For example, the online system selects an identified product matching a product included in at least a threshold amount of content previously accessed by the user.

The online system includes the selected product in the creative of the content item. For example, the online system requests content describing the selected product from the application from which content is included in the content item's creative and includes content presented by the application describing the selected product in the creative of the content item. This allows the online system to personalize the creative of the content item to present content from the application describing a product with which the user is likely to interact or describing a product in which the user is likely to have an interest.

Additionally, the online system associates instructions with the content item that, when executed by a client device, cause the client device to present the content describing the selected product via the application associated with the content item. For example, the instructions, when executed by the client device, launch the application associated with the content item and configure the application associated with the content item to display the content describing the selected product. In some embodiments, the instructions include an identifier of the application associated with the content item, an identifier of the selected product used by the application, and one or more commands that are executed by the application to present content associated with the selected product. Commands included in the instructions may identify information about the selected product presented by the application (e.g., an image of the selected product, a description of the selected product, a name of the selected product, or any other characteristics associated with the selected product by the application or by a third party system associated with the application).

In various embodiments, the online system stores an identifier of the content item, associates an identifier of the selected product used by the application from which content is included in the creative of the content item, and associates the instructions that, when executed by a client device, cause the client device to present the content describing the selected product via the application. Alternatively, the online system stores the identifier of the content item, associates an identifier of the application associated with the content item, associates an identifier of the selected product used by the application with the identifier of the content item, and associates the instructions with the identifier of the content item.

When the online system identifies an opportunity to present one or more content items to the user, the online system includes the content item, with the creative of the content item presenting content from the application including the selected product, in one or more selection processes selecting content for presentation to the user. A selection process may determine a likelihood of the user interacting with various content items, or determine a measure of relevance of various content items to the user, based on characteristics of the user and characteristics of the content item. Hence, including the content from the application that includes the selected product in the creative of the content item when the content item is included in the one or more selection processes affects the likelihood of the user interacting with the content item or the measure of relevance of the content item to the user. As the selected product was selected based on content previously accessed by the user, having the content from the application that includes the selected product in the creative of the content item increases a likelihood of the user interacting with the content item or increases a measure of relevance of the content item to the user, which may affect evaluation of the content item by one or more selection processes.

If the online system selects the content item having the creative presenting content from the application including the selected product for presentation to the user, the online system communicates the content item having the creative of the content item presenting content from the application including the selected product to a client device associated with the user for presentation. In various embodiments, the content item having the creative of the content item presenting content from the application including the selected product also includes a landing page specifying a network address for obtaining the application. If the user selects or otherwise accesses the content item having the creative of the content item presenting content from the application including the selected product, the client device obtains and installs the application via the network address specified by the landing page. As another example, the landing page includes an identifier of an installation application executing on the client device and an application identifier of the application. If the user selects or otherwise accesses the content item via the client device, the client device provides the identifier of the application to the installation application, which may prompt the user to install the application or may retrieve and install the application.

If the application is installed on the client device, the application transmits an indication of installation from the client device to the online system. For example, after installation on the client device, the application transmits an indication that the application has been installed on the client device to the online system. The indication transmitted to the online system includes an identifier of the client device, an identifier of the user of the online system, and the application identifier of the application. In various embodiments, the indication also includes an identifier of the content item having the creative of the content item presenting content from the application that includes the selected product.

In response to receiving the indication the application has been installed on the client device, the online system provides the instructions associated with the content item having the creative presenting content from the application including the selected product to the client device. When the application installed on the client device executes the instructions, the application presents the content describing the selected product via the client device. For example, after the client device receives the instructions from the online system, the application extracts an identifier of the selected product used by the application from the instructions and executes one or more commands in the instructions that configure the application to present content associated with the selected product.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment.

FIG. 3 flowchart of a method for generating a content item including content provided by an application identifying a product selected by the online system for presentation to a user of the online system, in accordance with an embodiment.

FIG. 4 is an interaction diagram of a method for providing a content item from an online system to a client device and providing instructions from the online system to the client device to launch an application to present content describing a product selected by the online system, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

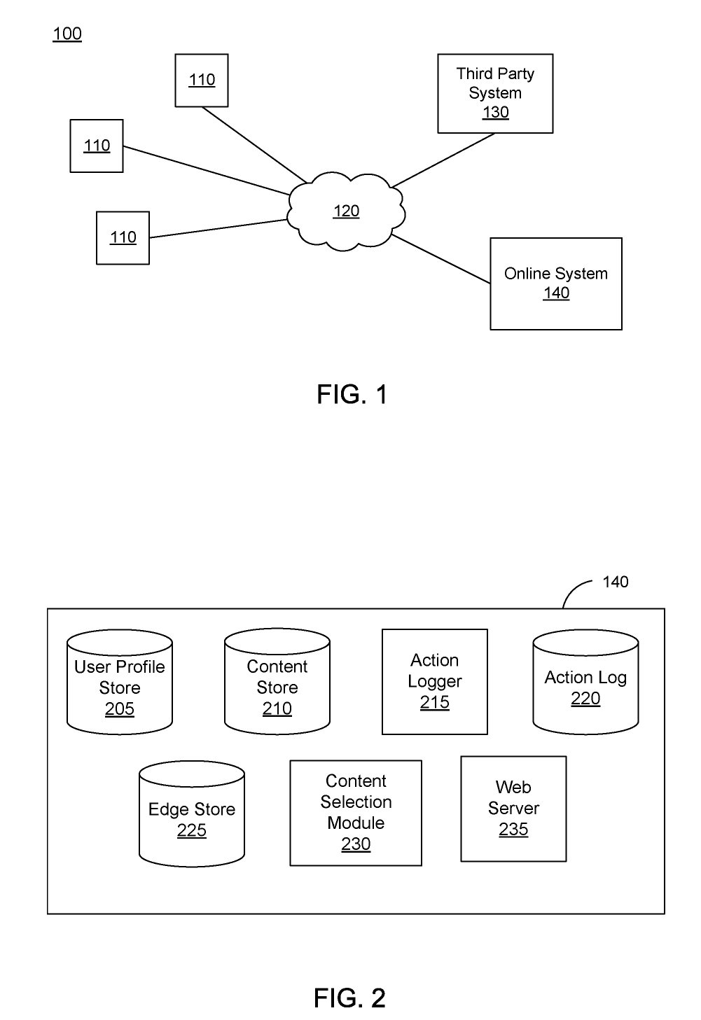

FIG. 1 is a block diagram of a system environment 100 for an online system 140. The system environment 100 shown by FIG. 1 comprises one or more client devices 110, a network 120, one or more third-party systems 130, and the online system 140. In alternative configurations, different and/or additional components may be included in the system environment 100. For example, the online system 140 is a social networking system, a content sharing network, or another system providing content to users.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone, a smartwatch, or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

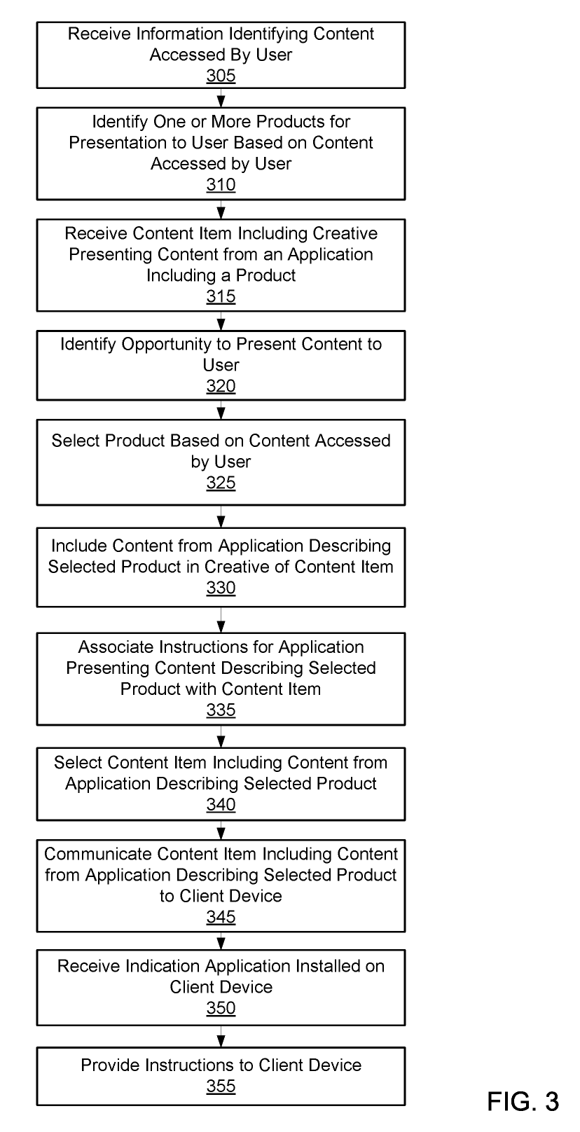

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party system 130 may also communicate information to the online system 140, such as advertisements, content, or information about an application provided by the third party system 130.

Various third party systems 130 provide content to users of the online system 140. For example, a third party system 130 maintains pages of content that users of the online system 140 may access through one or more applications executing on a client device 110. The third party system 130 may provide content items to the online system 140 identifying content provided by the online system 130 to notify users of the online system 140 of the content provided by the third party system 130. For example, a content item provided by the third party system 130 to the online system 140 identifies a page of content provided by the online system 140 that specifies a network address for obtaining the page of content. If the online system 140 presents the content item to a user who subsequently accesses the content item via a client device 110, the client device 110 obtains the page of content from the network address specified in the content item. This allows the user to more easily access the page of content.

FIG. 2 is a block diagram of an architecture of the online system 140. The online system 140 shown in FIG. 2 includes a user profile store 205, a content store 210, an action logger 215, an action log 220, an edge store 225, a content selection module 230, and a web server 235. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding social networking system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the social networking system users displayed in an image, with information identifying the images in which a user is tagged stored in the user profile of the user. A user profile in the user profile store 205 may also maintain references to actions by the corresponding user performed on content items in the content store 210 and stored in the action log 220.

Each user profile includes user identifying information allowing the online system 140 to uniquely identify users corresponding to different user profiles. For example, each user profile includes an electronic mail (“email”) address, allowing the online system 140 to identify different users based on their email addresses. However, a user profile may include any suitable user identifying information associated with users by the online system 140 that allows the online system 140 to identify different users.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other social networking system users. The entity may post information about itself, about its products or provide other information to users of the online system 140 using a brand page associated with the entity's user profile. Other users of the online system 140 may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Online system users may create objects stored by the content store 210, such as status updates, photos tagged by users to be associated with other objects in the online system 140, events, groups or applications. In some embodiments, objects are received from third-party applications or third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

One or more content items included in the content store 210 include a creative, which is content for presentation to a user, and a bid amount. The creative is text, image, audio, video, or any other suitable data presented to a user. In various embodiments, the creative also specifies a page of content. For example, a content item includes a landing page specifying a network address of a page of content to which a user is directed when the content item is accessed. The bid amount is included in a content item by a user and is used to determine an expected value, such as monetary compensation, provided by an advertiser to the online system 140 if content in the content item is presented to a user, if the content in the content item receives a user interaction when presented, or if any suitable condition is satisfied when content in the content item is presented to a user. For example, the bid amount included in a content item specifies a monetary amount that the online system 140 receives from a user who provided the content item to the online system 140 if content in the content item is displayed. In some embodiments, the expected value to the online system 140 of presenting the content from the content item may be determined by multiplying the bid amount by a probability of the content of the content item being accessed by a user.

Various content items may include an objective identifying an interaction that a user associated with a content item desires other users to perform when presented with content included in the content item. Example objectives include: installing an application associated with a content item, indicating a preference for a content item, sharing a content item with other users, interacting with an object associated with a content item, or performing any other suitable interaction. As content from a content item is presented to online system users, the online system 140 logs interactions between users presented with the content item or with objects associated with the content item. Additionally, the online system 140 receives compensation from a user associated with content item as online system users perform interactions with a content item that satisfy the objective included in the content item.

Additionally, a content item may include one or more targeting criteria specified by the user who provided the content item to the online system 140. Targeting criteria included in a content item request specify one or more characteristics of users eligible to be presented with the content item. For example, targeting criteria are used to identify users having user profile information, edges, or actions satisfying at least one of the targeting criteria. Hence, targeting criteria allow a user to identify users having specific characteristics, simplifying subsequent distribution of content to different users.

In one embodiment, targeting criteria may specify actions or types of connections between a user and another user or object of the online system 140. Targeting criteria may also specify interactions between a user and objects performed external to the online system 140, such as on a third party system 130. For example, targeting criteria identifies users that have taken a particular action, such as sent a message to another user, used an application, joined a group, left a group, joined an event, generated an event description, purchased or reviewed a product or service using an online marketplace, requested information from a third party system 130, installed an application, or performed any other suitable action. Including actions in targeting criteria allows users to further refine users eligible to be presented with content items. As another example, targeting criteria identifies users having a connection to another user or object or having a particular type of connection to another user or object.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with the particular users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions is stored in the action log 220. Examples of interactions with objects include: commenting on posts, sharing links, checking-in to physical locations via a client device 110, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce web sites, such as in the preceding example, may communicate information about a user's actions outside of the online system 140 to the online system 140 for association with the user. Hence, the action log 220 may record information about actions users perform on a third party system 130, including webpage viewing histories, advertisements that were engaged, purchases made, and other patterns from shopping and buying. Hence, the action log 220 may include information identifying content provided by one or more third party systems 130 that a user of the online system 140 has accessed or content provided by one or more third party systems 130 with which the user of the online system 140 otherwise interacted. Various third party systems 130 may include tracking mechanisms in content comprising instructions that, when executed by a client device 110, provide information identifying the content and identifying a user of the online system 140 associated with the client device 110 to the online system 140. The information identifying the content is stored in the action log 220 in association with information identifying the user to the online system 140. Additionally, actions a user performs via an application associated with a third party system 130 and executing on a client device 110 may be communicated to the action logger 215 by the application for recordation and association with the user in the action log 220.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140.

An edge may include various features each representing characteristics of interactions between users, interactions between users and objects, or interactions between objects. For example, features included in an edge describe a rate of interaction between two users, how recently two users have interacted with each other, a rate or an amount of information retrieved by one user about an object, or numbers and types of comments posted by a user about an object. The features may also represent information describing a particular object or user. For example, a feature may represent the level of interest that a user has in a particular topic, the rate at which the user logs into the online system 140, or information describing demographic information about the user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or in another user in the online system 140 based on the actions performed by the user. A user's affinity may be computed by the online system 140 over time to approximate the user's interest in an object, in a topic, or in another user in the online system 140 based on actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

The content selection module 230 selects one or more content items for communication to a client device 110 to be presented to a user. Content items eligible for presentation to the user are retrieved from the content store 210 or from another source by the content selection module 230, which selects one or more of the content items for presentation to the viewing user. A content item eligible for presentation to the user is a content item associated with at least a threshold number of targeting criteria satisfied by characteristics of the user or is a content item that is not associated with targeting criteria. In various embodiments, the content selection module 230 includes content items eligible for presentation to the user in one or more selection processes, which identify a set of content items for presentation to the user. For example, the content selection module 230 determines measures of relevance of various content items to the user based on characteristics associated with the user by the online system 140 and based on the user's affinity for different content items. Based on the measures of relevance, the content selection module 230 selects content items for presentation to the user. As an additional example, the content selection module 230 selects content items having the highest measures of relevance or having at least a threshold measure of relevance for presentation to the user. Alternatively, the content selection module 230 ranks content items based on their associated measures of relevance and selects content items having the highest positions in the ranking or having at least a threshold position in the ranking for presentation to the user.

Content items eligible for presentation to the user may include content items associated with bid amounts. The content selection module 230 uses the bid amounts associated with ad requests when selecting content for presentation to the user. In various embodiments, the content selection module 230 determines an expected value associated with various content items based on their bid amounts and selects content items associated with a maximum expected value or associated with at least a threshold expected value for presentation. An expected value associated with a content item represents an expected amount of compensation to the online system 140 for presenting the content item. For example, the expected value associated with a content item is a product of the ad request's bid amount and a likelihood of the user interacting with the content item. The content selection module 230 may rank content items based on their associated bid amounts and select content items having at least a threshold position in the ranking for presentation to the user. In some embodiments, the content selection module 230 ranks both content items not associated with bid amounts and content items associated with bid amounts in a unified ranking based on bid amounts and measures of relevance associated with content items. Based on the unified ranking, the content selection module 230 selects content for presentation to the user. Selecting content items associated with bid amounts and content items not associated with bid amounts through a unified ranking is further described in U.S. patent application Ser. No. 13/545,266, filed on Jul. 10, 2012, which is hereby incorporated by reference in its entirety.

For example, the content selection module 230 receives a request to present a feed of content to a user of the online system 140. The feed may include one or more content items associated with bid amounts and other content items, such as stories describing actions associated with other online system users connected to the user, which are not associated with bid amounts. The content selection module 230 accesses one or more of the user profile store 205, the content store 210, the action log 220, and the edge store 225 to retrieve information about the user. For example, information describing actions associated with other users connected to the user or other data associated with users connected to the user are retrieved. Content items from the content store 210 are retrieved and analyzed by the content selection module 230 to identify candidate content items eligible for presentation to the user. For example, content items associated with users who not connected to the user or stories associated with users for whom the user has less than a threshold affinity are discarded as candidate content items. Based on various criteria, the content selection module 230 selects one or more of the content items identified as candidate content items for presentation to the identified user. The selected content items are included in a feed of content that is presented to the user. For example, the feed of content includes at least a threshold number of content items describing actions associated with users connected to the user via the online system 140.

In various embodiments, the content selection module 230 presents content to a user through a newsfeed including a plurality of content items selected for presentation to the user. One or more content items may also be included in the feed. The content selection module 230 may also determine the order in which selected content items are presented via the feed. For example, the content selection module 230 orders content items in the feed based on likelihoods of the user interacting with various content items.

In various embodiments, the content selection module 230 also maintains information describing various products and selects a product for a user of the online system 140. For example, various third party systems 130 provide information to the content selection module 230 specifying characteristics of various products associated with the third party systems 130. As an example, a third party system 130 provides information to the content selection module 230 including identifiers of products sold or maintained by the third party system 130; associated with each identifier are one or more characteristics of a product corresponding to an identifier (e.g., a description of the product, keywords associated with the product, a name of the product, dimensions of the product, reviews of the product, etc.).

Based on information included in the action log 220 identifying content accessed by a user, the content selection module 230 selects a product from the maintained information for the user. In some embodiments, the content selection module 230 selects a product from the maintained information that was included in content accessed by the user. For example, the content selection module 230 selects a product that was described or otherwise included in at least a threshold amount of content accessed by the user. In other embodiments, the content selection module 230 selects a product based on characteristics of various products matching characteristics of content accessed by the user or characteristics of products included in content accessed by the user. For example, the content selection module 230 ranks products based on percentages of characteristics of the products matching characteristics of content accessed by the user and selects a product having a least a threshold position in the ranking. As further described below in conjunction with FIG. 3, the content selection module 230 may identify products associated with a particular third party system 130 and select a product from the identified products based on characteristics of various identified products that match characteristics of content accessed by the user or characteristics of products included in content accessed by the user.

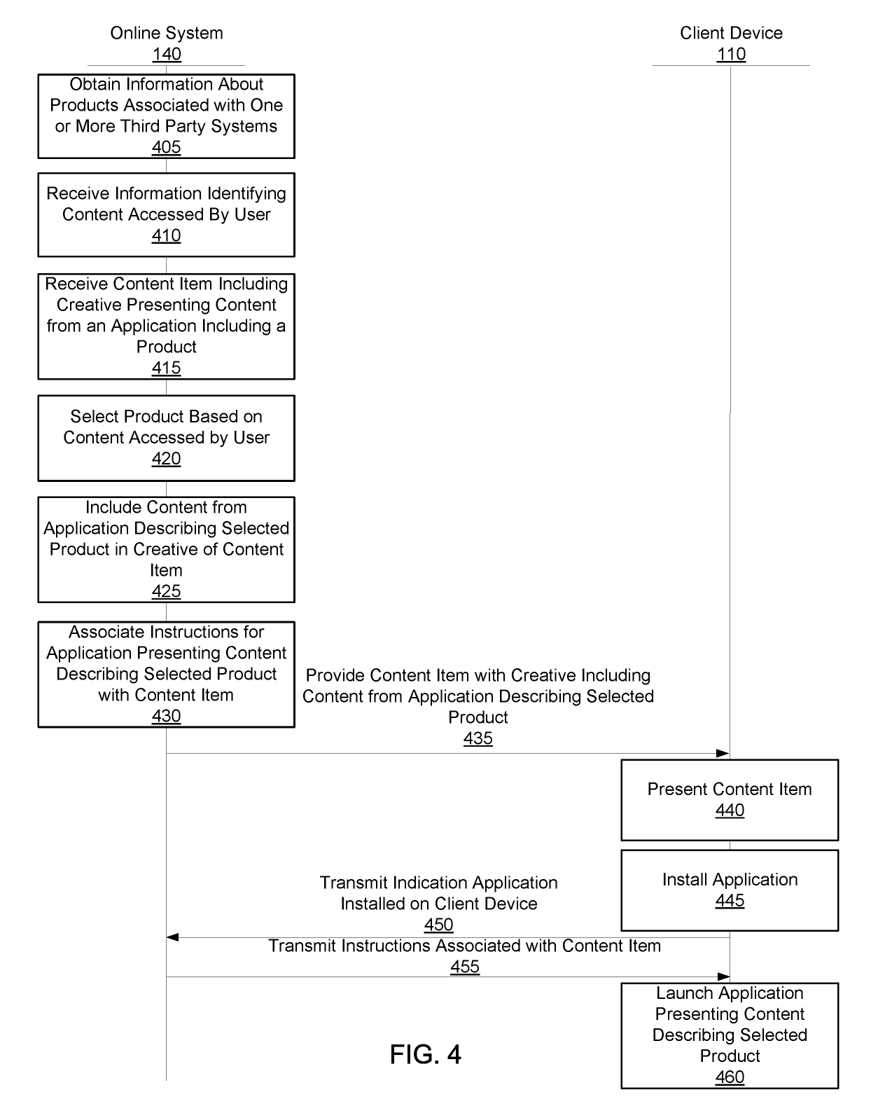

In various embodiments, a content item included in the content store 210 is associated with an application and includes instructions that, when executed by the content selection module 230, include content from the application including the selected product in the content item. For example, after selecting a product for the user, the content selection module 230 retrieves content from the application (e.g., by requesting the content from a third party system 130 associated with the application or by retrieving the content form the application). As further described below in conjunction with FIG. 3, after including content from the application including the selected product in the content item, the content selection product includes the content item in one or more selection processes selecting content for presentation to the user. Additionally, the content selection module 230 generates instructions that, when executed by a client device 110 presenting the content item, cause the client device 110 to launch the application and present the content including the selected content item, as further described below in conjunction with FIGS. 3 and 4.

The web server 235 links the online system 140 via the network 120 to the one or more client devices 110, as well as to the one or more third party systems 130. The web server 235 serves web pages, as well as other content, such as JAVA®, FLASH®, XML and so forth. The web server 235 may receive and route messages between the online system 140 and the client device 110, for example, instant messages, queued messages (e.g., email), text messages, short message service (SMS) messages, or messages sent using any other suitable messaging technique. A user may send a request to the web server 240 to upload information (e.g., images or videos) that are stored in the content store 210. Additionally, the web server 240 may provide application programming interface (API) functionality to send data directly to native client device operating systems, such as IOS®, ANDROID™, or BlackberryOS.

Generating a Content Item for Presentation to Users Including Content Provided by an Application Associated with a Third Party System Describing a Product

FIG. 3 is a flowchart of one embodiment of a method for generating a content item including content provided by an application associated with a third party system 140 identifying a product selected by the online system 140 for presentation to a user of the online system 140. In other embodiments, the method may include different and/or additional steps than those shown in FIG. 3. Additionally, steps of the method may be performed in different orders than the order described in conjunction with FIG. 3 in various embodiments.

As a user of the online system 140 accesses content provided by one or more third party systems 130, the online system 140 receives 305 information identifying the content accessed by the user. In various embodiments, content provided by different third party systems 130 includes information describing products associated with or provided by a third party system 130, and the online system 140 receives 305 information identifying products described by content from the third party system 130 accessed by the user. For example, a third party system 130 includes a tracking mechanism in content presented to users. The tracking mechanism comprises instructions that, when executed by a client device 110 presenting the content, obtain information identifying one or more products included in the content and information identifying the user to the online system 140 and communicate the information identifying the one or more products and identifying the user to the online system 140. In various embodiments, the tracking mechanism may communicate additional information to the online system 140 describing interaction with the content by the user of the online system 140. For example, the tracking mechanism communicates information describing one or more interactions by the user with various portions of the presented content corresponding to an identified product to the online system 140.

Various third party systems 130 provide the online system 140 with information describing products associated with or provided by the third party systems 130. For example, a third party system 130 provides the online system 140 with a catalog including product identifiers used by the third party system 130 for various products. The catalog also includes characteristics associated with different products by the third party system 130. For example, the catalog includes a product identifier associated with a product by the third party system 130 as well as a title, a description, one or more keywords, and any other suitable information associated with the product identifier. Different third party systems 130 may provide the online system 140 with different characteristics associated with products. In some embodiments, the online system 140 locally maintains information provided by a third party system 130 describing products provided by or associated with the third party system. For example, the online system 140 stores information describing products in association with an identifier of a third party system 130 that provided the information to the online system 140. Alternatively, the online system 140 retrieves information describing products from a third party system 130 associated with the products or providing the products.

Based on the received information identifying content provided by one or more third party systems 130 accessed by the user and the provided information describing products associated with or provided by one or more third party systems 130, the online system 140 identifies 310 one or more products for presentation to the user. In various embodiments, the online system 140 compares characteristics of content accessed by the user to characteristics of products associated with or provided by various third party systems 130 and identifies 310 one or more products having at least a threshold amount (e.g., at least a threshold number or at least a threshold percentage) of characteristics matching characteristics of content accessed by the user. For example, the online system 140 determines products included in content accessed by the user, obtains characteristics of the determined products, and identifies 310 additional products having at least a threshold amount of characteristics matching characteristics of the determined products. As another example, the online system 140 extracts keywords, topics, or other information from the content accessed by the user and identifies 310 products described by the provided information having at least the threshold amount of characteristics matching the extracted keywords, topics, or other information.

The online system 140 also receives 315 a content item for presentation to one or more users of the online system 140 that includes a creative presenting content from an application associated with a third party system 130 that includes a product. To increase a likelihood of users interacting with the content item when it is presented, the content item includes instructions that cause the online system 140 to select the product included in the content presented by the creative and generate the creative for the content item based on the selection. Hence, rather than identify a specific content item that is presented to each user to whom the content item is presented, the instructions included in the content item allow the online system 140 to dynamically identify the product presented by the creative for different users. The online system 140 may receive 315 the content item from the third party system 130 associated with the application presenting the content included in the creative or may receive 315 the content item from another third party system 130 or from another entity.

When the online system 140 identifies 320 an opportunity to present one or more content items to the user, the online system 140 identifies products associated with the third party system 130 associated with the application and selects 325 product associated with the third party system 130 associated with the application for inclusion in the creative. In various embodiments, the online system 140 selects 325 product in response to determining the content item is eligible for presentation to the user. The content item is eligible to be presented to the user if the user is associated with characteristics satisfying at least a threshold amount of targeting criteria included in the content item or if the content item does not include targeting criteria.

To select 325 the product, the online system 140 determines products associated with the third party system associated with the application and determines likelihoods of the user interacting with content including each of at least a set of the determined products. For example, the online system 140 generates different content items that each include an identified product and determines likelihoods of the user interacting with each of the generated content items. To determine a likelihood of the user interacting with a generated content item, the online system 140 may apply one or more models to characteristics of the user and characteristics of the generated content item. The one or more models may be based on prior interactions by the user with previously presented content items. Based on the determined likelihoods, the online system 140 selects 325 an identified product. For example, the online system 140 selects 325 a determined product included in a generated content item with which the user had a maximum likelihood of interacting. In other embodiments, the online system 140 selects 325 a determined product included in a generated content item having at least a threshold likelihood of interaction. As another example, the online system 140 ranks the determined products based on likelihoods of the user interacting with generated content items including the determined products and selects 325 a product included in a generated content item having at least a threshold position in the ranking. In other embodiments, the online system 140 selects 325 an identified product associated with the third party system 130 matching a product included in content accessed by the user. For example, the online system 140 selects 325 a product associated with the third party system 130 matching a product included in at least a threshold amount of content previously accessed by the user.

The online system 140 includes 330 the selected product in the creative of the content item. For example, the online system 140 requests content presented by the application associated with the third party system 130 describing the selected product from the third party system 130, and includes 330 content presented by the application associated with the third party system 130 describing the selected product in the creative of the content item. This allows the online system 140 to personalize the creative of the content item to present content from the application describing a product with which the user is likely to interact or describing a product in which the user is likely to have an interest.

In addition to including 330 the selected product in the creative of the content item, the online system 140 associates 335 instructions with the content item that, when executed by a client device 110, cause the client device 110 to present the content describing the selected product via the application associated with the third party system 130. For example, the instructions, when executed by the client device 110, launch the application associated with the third party system 130 and configure the application associated with the third party system 130 to display the content describing the selected product. In some embodiments, the instructions include an identifier of the application associated with the third party system 130, an identifier of the selected product used by the third party system 130, and one or more commands that are executed by the application associated with the third party system 130 to present content associated with the selected product by the third party system 130. Commands included in the instructions may identify information about the selected product presented by the application associated with the third party system 130 (e.g., an image of the selected product, a description of the selected product, a name of the selected product, or any other characteristics associated with the selected product by the third party system 130 or by the application associated with the third party system 130). Additionally, commands included in the instructions may specify other information other than information about the selected product that is presented by the application associated with the third party system 130 (e.g., information identifying the third party system 130, graphics or images presented by the application, text information presented by the application or included in fields of the application, or any other suitable information).

In various embodiments, the online system 140 stores an identifier of the content item, associates an identifier of the selected product used by the third party system 130 with the identifier of the content item, and associates the instructions that, when executed by a client device 110, cause the client device 110 to present the content describing the selected product via the application associated with the third party system 130, with the identifier of the content item. In another embodiment, the online system 140 stores the identifier of the content item, associates an identifier of the application associated with the third party system 130 with the identifier of the content item, associates an identifier of the selected product used by the third party system 130 with the identifier of the content item, and associates the instructions with the identifier of the content item. However, in various embodiments, the online system 140 may store any suitable information to associate 335 the instructions with the content item.

When the online system 140 identifies an opportunity to present one or more content items to the user and the content item is eligible for presentation to the user, the online system 140 includes the content item, having the creative of the content item presenting content from the application associated with the third party system 130 that includes the selected product, in one or more selection processes selecting content for presentation to the user. The content item is eligible for presentation to the user if the content item includes at least a threshold amount of targeting criteria satisfied by characteristics of the user or if the content item does not include targeting criteria. Examples of selection processes used by the online system 140 to select content for presentation to the user are further described above in conjunction with FIG. 2. For example, a selection process determines a likelihood of the user interacting with various content items, or a measure of relevance of various content items to the user, based on characteristics of the user and characteristics of the content item. Hence, including the content from the application associated with the third party system 130 that includes the selected product in the creative of the content item when included in the one or more selection processes affects the likelihood of the user interacting with the content item or the measure of relevance of the content item to the user. As the online system 140 selects 325 the selected products based on content previously accessed by the user, having the content from the application associated with the third party system 130 that includes the selected product in the creative of the content item increases a likelihood of the user interacting with the content item or increases a measure of relevance of the content item to the user, which may affect evaluation of the content item by one or more selection processes.

If the online system 140 selects 340 the content item having the creative of the content item presenting content from the application associated with the third party system 130 that includes the selected product for presentation to the user, the online system 140 communicates 345 the content item having the creative of the content item presenting content from the application associated with the third party system 130 that includes the selected product to a client device 110 associated with the user for presentation. For example, if the content item having the creative of the content item presenting content from the application associated with the third party system 130 that includes the selected product has at least a threshold measure of relevance or at least a threshold likelihood of obtaining an interaction by the user, the online system 140 selects 340 and communicates 345 the content item having the creative of the content item presenting content from the application associated with the third party system 130 that includes the selected product to a client device 110 for presentation to the user. As another example, if the content item is associated with a bid amount, one or more selection processes determine expected values to the online system 140 of presenting various content items based on bid amounts included in the content items and likelihoods of the user interacting with the content items. One or more selection processes rank the content items by their expected values, and the online system 140 selects 340 the content item having the creative of the content item presenting content from the application associated with the third party system 130 that includes the selected product if the content item having the creative of the content item presenting content from the application associated with the third party system 130 that includes the selected product has at least a threshold position in the ranking.

In various embodiments, the content item having the creative of the content item presenting content from the application associated with the third party system 130 that includes the selected product also includes a landing page specifying a network address for obtaining the application associated with the third party system 130. If the user selects or otherwise accesses the content item having the creative of the content item presenting content from the application associated with the third party that includes the selected product, the client device 110 obtains and installs the application via the network address specified by the landing page. As another example, the landing page includes an identifier of an installation application executing on the client device 110 and an application identifier of the application associated with the third party system 130. If the user selects or otherwise accesses the content item via the client device 110, the client device 110 provides the identifier of the application associated with the third party system 130 to the installation application, which may prompt the user to install the application associated with the third party system 130 or may retrieve and install the application from the third party system 130.

If the application associated with the third party system 130 is installed on the client device 110, the application associated with the third party system 130 transmits an indication of installation from the client device 110 to the online system 140. For example, after installation on the client device 110 has completed, the application associated with the third party system 130 transmits an indication that the application associated with the third party system 130 has been installed on the client device 110 from the client device 110 to the online system 140. The indication transmitted to the online system 140 includes an identifier of the client device 110, an identifier of the user of the online system 140, and the application identifier of the application associated with the third party system 130. In various embodiments, the indication also includes an identifier of the content item having the creative of the content item presenting content from the application associated with the third party system 130 that includes the selected product.

In response to receiving 350 the indication the application associated with the third party system 130 has been installed on the client device 110, the online system 140 provides 355 the instructions associated with the content item having the creative presenting content from the application associated with the third party system 130 that includes the selected product to the client device 110. As further described above, when the instructions are executed by the application associated with the third party system 130, the application associated with the third party system 130 presents the content describing the selected product via the client device 110. For example, after receiving the instructions from the online system 140, the application associated with the third party system 130 extracts an identifier of the selected product used by the third party system 130 from the instructions and executes one or more commands in the instructions that configure the application associated with the third party system 130 to present content associated with the selected product. As further described above, the instructions may also identify other information presented by the application associated with the third party system 130, further customizing content presented by the application associated with the third party system 130.

In some embodiments, the instructions are included in the content item having the creative presenting content from the application associated with the third party system 130 that includes the selected product when the content item is communicated 345 from the online system 140 to the client device 110. The client device 110 stores the instructions in a location accessible to the application associated with the third party system 130 when the content item is presented to the user. For example, the content item having the creative presenting content from the application associated with the third party system 130 that includes the selected product is presented via the client device 110 by an application associated with the online system 140, which stores the instructions in a shared memory location on the client device 110 accessible to the application associated with the third party system 130. Subsequently, if the application associated with the third party system 130 is installed on the client device 110, the application associated with the third party system 130 obtains the instructions from the location on the client device 110 accessible to the application associated with the third party system 130 (e.g., from the shared memory location) and executes the instructions to present content including the selected product via the client device 110.

In various embodiments, when the online system 140 receives 350 the indication the application associated with the third party system 130 has been installed on the client device 110, the online system 140 determines whether the content item having the creative presenting content from the application associated with the third party system 130 that includes the selected product was presented to the user prior to installation of the application on the client device 110. For example, the indication includes an identifier of the application associated with the third party system 130, a time when the application associated with the third party system 130 was installed on the client device 110, and information identifying the user to the online system 140. The online system 140 retrieves stored information identifying content previously presented to the user by the online system 140 from the information identifying the user. If the online system 140 determines the item content item having the creative presenting content from the application associated with the third party system 130 that includes the selected product was presented to the user within a threshold amount of time from the time when the application associated with the third party system 130 was installed on the client device 110, the online system 140 provides 355 the instructions associated with the content item having the creative presenting content from the application associated with the third party system 130 that includes the selected product to the client device 110, as further described above. In other embodiments, the online system 140 retrieves stored information describing actions performed by the user from the information identifying the user to the online system 140 and provides 355 the instructions to the client device 110 in response to determining the user performed one or more specific types of interactions with the content item having the creative presenting content from the application associated with the third party system 130 that includes the selected product within a threshold amount of time from the time when the application associated with the third party system 130 was installed on the client device 110.

FIG. 4 is an interaction diagram of one embodiment of a method for an online system 140 providing a content item to a client device 110 and providing instructions to the client device 110 to launch an application associated with the client device 110 to present content describing a particular product. In other embodiments, the method may include different and/or additional steps than those shown in FIG. 4. Additionally, steps of the method may be performed in different orders than the order described in conjunction with FIG. 4 in various embodiments.

As described above in conjunction with FIG. 3, the online system 140 obtains 405 information about products associated with one or more third party systems 130. For example, a third party system 130 provides the online system 140 with information including identifiers of various products provided by the third party system 130, characteristics of various products provided by the third party system 130 (e.g., descriptions of products, keywords associated with products, pricing information for products, or any other suitable information). The online system 140 may periodically request information about products from various third party systems 130. Additionally or alternatively, a third party system 130 may provide information describing products to the online system 140 without receiving a request from the online system 140. For example, a third party system 130 provides information describing a product that is newly associated with the third party system 130 (e.g., a product newly offered for sale by the third party system 130). As another example, a third party system 130 periodically communicates information describing products associated with the third party system 130 to the online system 140.

The online system 140 also receives 410 information describing content accessed by a user of the online system 140 from various third party systems 130, as further described above in conjunction with FIG. 3. For example, various third party systems 130 include tracking mechanisms in content provided by the third party system 130. A tracking mechanism comprises instructions that, when executed by a client device 110 presenting the content, communicate information to the online system 140 identifying the content including the tracking mechanism and presented by the client device 110 and information capable of identifying the user to the online system 140. Different third party systems 130 include tracking mechanisms in various content provided by the third party systems 130 to provide information to the online system 140 identifying content from the various third party systems 130 presented to the user. The online system 140 stores information identifying content presented or otherwise accessed by the user received 410 from tracking mechanisms included in content provided by various third party systems 130. In other embodiments, the online system 140 may receive 410 information describing content accessed by the user from third party systems 130 themselves or from any suitable source.

As further described above in conjunction with FIG. 3, the online system 140 receives 415 a content item including a creative that includes a creative presenting content from an application that includes a product. In various embodiments, the application is associated with a third party system 130 or with the online system 140. To increase a likelihood of users interacting with the content item when it is presented, the content item includes instructions that cause the online system 140 to select the product included in the content presented by the creative and generate the creative for the content item based on the selection, as further described above in conjunction with FIG. 3. Hence, the instructions included in the content item allow the online system 140 to dynamically determine the creative of the content item for presentation to the user, so the content item may present different content to different users. As described above in conjunction with FIG. 3, the online system 140 may receive 415 the content item from a third party system 130 associated with the application presenting the content included in the creative or receive 415 the content item from another third party system 130 or from another entity. Further, the online system 140 may generate the content item itself in some embodiments.

The online system 140 selects 420 a product from the products about which the online system 140 obtained 405 information and the information describing content accessed by the user. As further described above in conjunction with FIG. 3, the online system 140 selects 420 a product having at least a threshold amount of characteristics matching characteristics of content accessed by the user or selects a product having at least a threshold amount of characteristics matching a product included in or associated with content accessed by the user. In other embodiments, the online system 140 selects 420 a product from the products about which the online system 140 obtained 405 information that was associated with, or included in, at least a threshold amount of content accessed by the user.

As further described above in conjunction with FIG. 3, the online system 140 includes content from the application including the selected product and associates instructions 430 with the content item that, when executed, cause a client device 110 to launch the application and present the content including the selected product. For example, the instructions include an application identifier of the application, an identifier used by the application to identify the selected product, and one or more commands identifying content presented by the application. In some embodiments, the online system 140 stores an identifier of the content item and stores an identifier of the selected product, as well as the instructions in association with the identifier of the content item. As another example, the online system 140 stores an identifier of the content item in association with the application identifier of the application, an identifier of the selected product, and the instructions.

The online system 140 includes the content item with its creative including content from the application including the selected product in one or more selection processes selecting content for presentation to the user, as further described above in conjunction with FIGS. 2 and 3. If the online system 140 selects the content item having the creative including content from the application including the selected product for presentation to the user, the online system 140 provides 435 the content item to a client device 110 associated with the user, which presents 440 the content item. For example, the client device 110 executes an application associated with the online system 140 that presents 440 the content item to the user.

If the user subsequently installs 445 the application having the content including the selected product on the client device 110, the client device 110 transmits 450 an indication the application has been installed on the client device 110 to the online system 140. For example, if the user interacts with the content item while it is presented 440 by the client device 110, the client device 110 retrieves content from a landing page of the content item that installs 450 the application from a source specified by the landing page. For example, the user accessing the presented content item causes the client device 110 to obtain and install 445 the application from a third party system 130. As another example, the user accessing the presented content item causes the client device 110 to launch an installation application, identify the application via the installation application, and prompt the user to install the application via the installation application. In some embodiments, the client device 110 transmits 450 the indication the application was installed on the client device 110 if the application was installed 445 within a threshold amount of time after the content item was presented 440. Alternatively, the client device 110 transmits 450 the indication the application was installed 445 in response to the application being installed 445 on the client device 110.

In various embodiments, when the online system 140 receives the indication the application has been installed 445 on the client device 110, the online system 140 determines whether the content item having the creative presenting content from the application including the selected product was presented 440 to the user prior to installation of the application on the client device 110. For example, the indication includes an identifier of the application associated with the third party system 130, a time when the application associated with the third party system 130 was installed on the client device 110, and information identifying the user to the online system 140. From stored information identifying content presented to the user, if the online system 140 determines the content item including content from the application including the selected product was presented to the user within a threshold amount of time from the time when the application was installed 445 on the client device 110, the online system 140 transmits 455 the instructions associated with the content item having the creative presenting content from the application that includes the selected product to the client device 110. In other embodiments, the online system 140 transmits 455 the instructions to the client device 110 if information stored by the online system 140 identifying actions performed by the user indicates the user performed one or more specific types of interactions with the content item within a threshold amount of time from the time when the application associated with the third party system 130 was installed on the client device 110. For example, the online system 140 transmits 455 the instructions associated with the content item to the client device 110 if the online system 140 includes information indicating the user accessed the content item (e.g., selected) within a threshold amount of time from the time when the application was installed 445 on the client device 110.

When the client device 110 receives the instructions from the online system 140, the application executes the instructions and launches 460 the application with the application presenting the content describing the selected product that was included. Executing the instructions causes the client device 110 to launch 460 the application so content including the selected product is presented to the user. As the selected product is a product in which the online system 140 determined the user likely has an interest, initially presenting content including the selected product via the application may increase the user's subsequent interaction with the application by allowing the user to more easily view content via the application that was previously presented to the user via the content item.

### Summary

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving information identifying content provided by one or more third party systems accessed by a user of an online system;
identifying one or more products for presentation to the user of the online system based on the content provided by the one or more third party systems accessed by the user of the online system and characteristics of the products;
receiving a content item at the online system for presentation to one or more users of the online system, the content item including a creative presenting content from an application associated with a third party system that includes a product;
identifying an opportunity to present one or more content items to the user of the online system;
selecting a product of the products associated with the third party system based on likelihoods of the user accessing content presenting each of at least a set of the products associated with the third party system;
including the selected product in the creative of the content item;
associating instructions with the content item including the selected product in the creative, the instructions, when executed, obtain content from the third party system describing the selected product for presentation via the application associated with the third party system;
selecting the content item having the creative including content from the application including the selected product for presentation to the user; and
communicating the content item including the associated instructions and having the creative presenting content including the selected product from the application to a client device for presentation to the user.

2. The method of claim 1, further comprising:
receiving, at the online system, an indication from the application associated with the third party system executing on the client device that the application associated with the third party system is installed on the client device.

3. The method of claim 1, wherein identifying one or more products for presentation to the user of the online system based on the content provided by the one or more third party systems accessed by the user of the online system and characteristics of the products comprises:
retrieving characteristics of at least a set of the products;
determining characteristics of content provided by the one or more third party systems accessed by the user of the online system; and
identifying products having at least a threshold amount of characteristics matching characteristics of the content provided by the one or more third party systems accessed by the user of the online system.

4. The method of claim 3, wherein retrieving characteristics of at least a set of the products comprises:
obtaining information from the third party system describing characteristics of one or more products offered by the third party system; and
retrieving characteristics of one or more products from the obtained information.

5. The method of claim 1, wherein selecting the product of the candidate products associated with the third party system based on likelihoods of the user accessing content presenting each of at least a set of the candidate products associated with the third party system comprises:
identifying candidate products associated with the third party system from the products;
determining likelihoods of the user accessing content including each of the identified candidate products; and
selecting a candidate product based on the determined likelihoods.

6. The method of claim 5, wherein selecting the candidate product based on the determined likelihoods comprises:
selecting a candidate product associated with at least a threshold likelihood.

7. The method of claim 5, wherein selecting the candidate product based on the determined likelihood comprises:
ranking the candidate products based on the likelihoods; and
selecting the candidate product based on the ranking.

8. The method of claim 1, wherein associating instructions with the content item including the selected product in the creative comprises:
obtaining an identifier associated with the selected product by the application associated with the third party system; and
generating instructions for execution by the application associated with the third party system that, when executed, retrieve content associated with the obtained identifier for presentation.

9. The method of claim 1, wherein receiving, at the online system, the indication from the application associated with the third party system executing on the client device comprises:
receiving the indication from the application in response to installation of the application associated with the third party system on the client device.

10. The method of claim 1, wherein providing the instructions associated with the content item including the selected product in the creative to the application associated with the third party system and executing on the client device comprises:
providing the instructions to the client device in response to determining the application associated with the third party system is installed on the client device within a threshold amount of time of a time when the content item having the creative presenting content including the selected product from the application was presented to the user.

11. The method of claim 1, wherein providing the instructions associated with the content item including the selected product in the creative to the application associated with the third party system and executing on the client device comprises:
providing the instructions to the client device in response to determining the application associated with the third party system is installed on the client device within a threshold amount of time of a time when the user performed an interaction with the content item having the creative presenting content including the selected product from the application.

12. A method comprising:
receiving information identifying content provided by one or more third party systems accessed by a user of an online system;
identifying one or more products for presentation to the user of the online system based on the content provided by the one or more third party systems accessed by the user of the online system and characteristics of the products;
receiving a content item at the online system for presentation to one or more users of the online system, the content item including a creative presenting content from an application that includes a product;
identifying an opportunity to present one or more content items to the user of the online system;
selecting a product of the products associated with the third party system based on likelihoods of the user accessing content presenting each of at least a set of the products associated with the third party system;
including the selected product in the creative of the content item;
associating instructions with the content item including the selected product in the creative, the instructions, when executed, configure the application to present the content describing the selected product; and
selecting the content item including the associated instructions and having the creative including content from the application including the selected product for presentation to the user;
communicating the content item including the associated instructions having the creative presenting content including the selected product from the application to a client device for presentation to the user.

13. The method of claim 12, wherein identifying one or more products for presentation to the user of the online system based on the content provided by the one or more third party systems accessed by the user of the online system and characteristics of the products comprises:
retrieving characteristics of at least a set of the products;
determining characteristics of content provided by the one or more third party systems accessed by the user of the online system; and
identifying products having at least a threshold amount of characteristics matching characteristics of the content provided by the one or more third party systems accessed by the user of the online system.

14. The method of claim 13, wherein retrieving characteristics of at least a set of the products comprises:
obtaining information from the one or more third party systems describing characteristics of one or more products offered by the one or more third party systems; and
retrieving characteristics of one or more products from the obtained information.

15. The method of claim 12, wherein selecting the product of the candidate products associated with the third party system based on likelihoods of the user accessing content presenting each of at least a set of the candidate products associated with the third party system comprises:
identifying candidate products associated with a third party system associated with the application from the products;
determining likelihoods of the user accessing content including each of the identified candidate products; and
selecting a candidate product based on the determined likelihoods.

16. The method of claim 12, wherein selecting the product of the products associated with the third party system based on likelihoods of the user accessing content presenting each of at least a set of the products associated with the third party system:
selecting a product of the products matching a product included in at least a threshold amount of the content provided by the one or more third party systems that was accessed by the user.

17. The method of claim 12, wherein associating instructions with the content item including the selected product in the creative comprises:
obtaining an identifier associated with the selected product by the application; and
generating instructions for execution by the application that, when executed, retrieve content associated with the obtained identifier for presentation.

18. The method of claim 12, wherein providing the instructions associated with the content item including the selected product in the creative to the application executing on the client device comprises:
providing the instructions to the client device in response to determining the application was installed on the client device within a threshold amount of time of a time when the content item having the creative presenting content including the selected product from the application was presented to the user.

19. The method of claim 12, wherein providing the instructions associated with the content item including the selected product in the creative to the application associated with the third party system and executing on the client device comprises:
providing the instructions to the client device in response to determining the application was installed on the client device within a threshold amount of time of a time when the user performed an interaction with the content item having the creative presenting content including the selected product from the application.

20. A computer program product comprising a computer readable storage medium having instructions encoded thereon that, when executed by a processor, cause the processor to:
receive information identifying content provided by one or more third party systems accessed by a user of an online system;
identify one or more products for presentation to the user of the online system based on the content provided by the one or more third party systems accessed by the user of the online system and characteristics of the products;
receive a content item at the online system for presentation to one or more users of the online system, the content item including a creative presenting content from an application that includes a product;
identify an opportunity to present one or more content items to the user of the online system;
select a product of the products associated with the third party system based on likelihoods of the user accessing content presenting each of at least a set of the products associated with the third party system;
include the selected product in the creative of the content item;
associate instructions with the content item including the selected product in the creative, the instructions, when executed, configure the application to present the content describing the selected product;
select the content item having the creative including content from the application including the selected product for presentation to the user;
communicate the content item including the associated instructions and having the creative presenting content including the selected product from the application to a client device for presentation to the user.
